(19) United States
(12) Patent Application Publication
(10) Pub. No.: US 2025/0010480 A1
(43) Pub. Date: Jan. 9, 2025

(54) DEVICE, INDUSTRIAL MACHINE AND METHOD FOR VERIFYING OPERATION OF INDUSTRIAL MACHINE

(71) Applicant: Fanuc Corporation, Minamitsuru-gun, Yamanashi (JP)

(72) Inventor: Toshiyuki ANDO, Minamitsuru-gun, Yamanashi (JP)

(73) Assignee: Fanuc Corporation, Minamitsuru-gun, Yamanashi (JP)

(21) Appl. No.: 18/712,340

(22) PCT Filed: Dec. 7, 2021
(86) PCT No.: PCT/JP2021/044960

§ 371 Date: May 22, 2024

(51) Int. Cl. B25J 9/16

(52) U.S. Cl. CPC B25J 9/1697; B25J 9/163; B25J 9/1661

(57) ABSTRACT

A device for verifying the operation of an industrial machine that controls operations based on detection data of a sensor includes: a detection data acquisition unit that acquires detection data detected by the sensor during execution of an operation program that includes a plurality of commands causing the industrial machine to execute a plurality of operations; and an association generation unit that associates the executed commands and the detection data used in the control of the operations performed by the executed commands with each other.

### CROSS REFERENCE TO RELATED APPLICATIONS

This is the U.S. National Phase application of PCT/JP2021/044960, filed Dec. 7, 2021, the disclosures of this application being incorporated herein by reference in its entirety for all purposes.

### FIELD OF THE INVENTION

The present disclosure relates to a device, industrial machine and a method for verifying an operation of an industrial machine.

### BACKGROUND OF THE INVENTION

In the related art, there is known a technology for verifying whether or not detection data of a sensor (e.g., a vision sensor) is appropriately detected in an industrial machine that controls an operation based on the detection data (e.g., Patent Literature 1).

### PATENT LITERATURE

PTL 1: JP 5-12409 A

### SUMMARY OF THE INVENTION

There is a demand for a technology capable of more easily verifying an operation of an industrial machine such as the above-described one.

In one aspect of the present disclosure, a device for verifying an operation of an industrial machine controlling the operation based on detection data of a sensor includes: a detection data acquiring unit that acquires the detection data detected by the sensor when executing an operation program including a plurality of instructions for causing the industrial machine to perform a plurality of the operations respectively; and an association generating unit that associates the executed instruction and the detection data used for control of the operation performed by the executed instruction with each other.

In another aspect of the present disclosure, a method of verifying an operation of an industrial machine controlling the operation based on detection data of a sensor includes: acquiring, by a processor, the detection data detected by the sensor when executing an operation program including a plurality of instructions causing the industrial machine to perform a plurality of the operations respectively; and associating, by the processor, the executed instruction and the detection data used for control of the operation performed by the executed instruction with each other.

According to the present disclosure, an operator can search, from an instruction for performing an operation causing a malfunction, for detection data used for control of the operation. As a result, it is possible to facilitate work for verifying a cause of the malfunction in the operation of the industrial machine by checking whether or not the detection data has been erroneously detected.

### BRIEF DESCRIPTION OF DRAWINGS

FIG. 1 is a schematic diagram of an industrial machine according to an embodiment.

FIG. 2 is a block diagram of the industrial machine illustrated in FIG. 1.

FIG. 3 illustrates an example of an operation program.

FIG. 4 illustrates an example of detection data detected by a sensor.

FIG. 5 illustrates an example of setting image data for setting an operation parameter of the industrial machine.

FIG. 6 is a schematic diagram of an industrial machine according to another embodiment.

FIG. 7 is a block diagram of the industrial machine illustrated in FIG. 6.

FIG. 8 illustrates an example of an operation process of the industrial machine illustrated in FIG. 6.

FIG. 9 illustrates an example of a process of step S8 in FIG. 8.

FIG. 10 illustrates an example of operation verification image data.

FIG. 11 is a schematic diagram of an industrial machine according to still another embodiment.

FIG. 12 is a block diagram of the industrial machine illustrated in FIG. 11.

### DETAILED DESCRIPTION OF EMBODIMENTS OF THE INVENTION

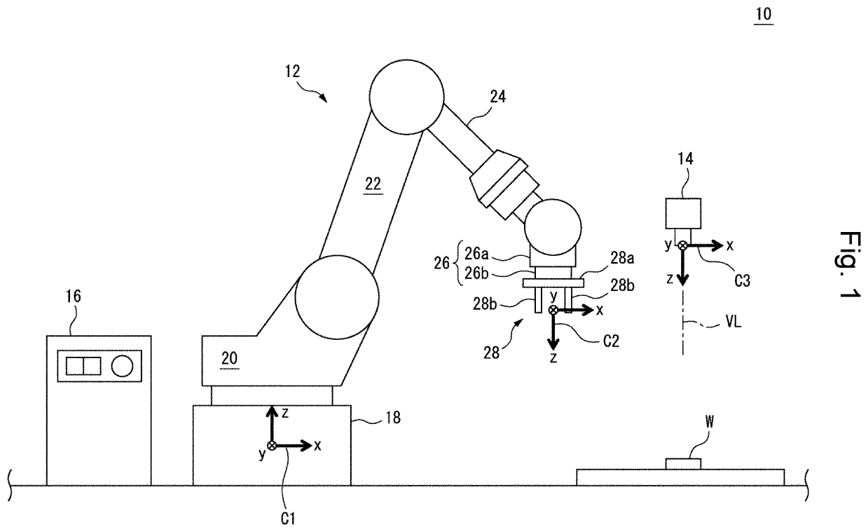

Embodiments of the present disclosure are described in detail below with reference to the drawings. Note that in various embodiments described below, the same elements are denoted with the same reference numerals, and overlapping description is omitted. Referring first to FIG. 1, an industrial machine 10 according to an embodiment will be described. The industrial machine 10 includes a robot 12, a sensor 14, and a controller 16.

In the present embodiment, the robot 12 is a vertical articulated robot and includes a robot base 18, a swivel barrel 20, a lower arm 22, an upper arm 24, a wrist 26, and an end effector 28. The robot base 18 is fixed to a floor of a work cell. The swivel body 20 is provided at the robot base 18 rotatably about a vertical axis.

The lower arm 22 is provided at the swivel body 20 rotatably about a horizontal axis, and the upper arm 24 is rotatably provided at a distal end of the lower arm 22. The wrist 26 includes a wrist base 26a provided at a distal end of the upper arm 24 rotatably about two axes orthogonal to each other, and a wrist flange 26b rotatably provided at the wrist base 26a.

The end effector 28 is detachably attached to the wrist flange 26b and carries out a predetermined work on a workpiece W. In the present embodiment, the end effector 28 is a robot hand capable of gripping the workpiece W, and includes a hand base 28a coupled to the wrist flange 26b and a plurality of claw parts 28b provided at the hand base 28a so as to be openable and closable.

The end effector 28 can grip or release the workpiece W by opening or closing the claw parts 28b in response to a command from the controller 16. Note that the end effector 28 may be a robot hand that includes a suction part (a negative pressure generating device, a suction cup, or the like) capable of sucking an object, and that sucks and grips the workpiece W with the suction part.

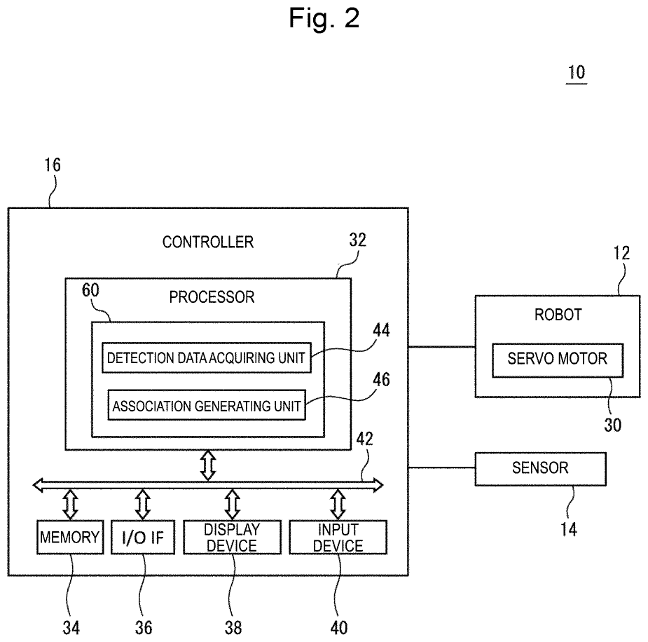

A plurality of servo motors 30 (FIG. 2) are provided at each of the robot base 18, the swivel body 20, the lower arm 22, the upper arm 24, and the wrist 26. In response to a command from the controller 16, the servo motors 30 rotate each of the swivel body 20, the lower arm 22, the upper arm 24, the wrist 26, and the wrist flange 26b about the drive shaft, thereby moving the end effector 28. The robot 12 carries out a workpiece handling work of handling the workpiece W (e.g., work of loading the workpiece or work of taking out the workpiece) with the end effector 28 while moving the end effector 28.

In the present embodiment, the sensor 14 is a vision sensor that detects the workpiece W by imaging the workpiece W. Specifically, the sensor 14 is a three-dimensional vision sensor including an image sensor (CMOS, CCD, or the like) and an optical lens (collimating lens, focusing lens, or the like) that guides a subject image to the image sensor, and is configured to image a subject along a visual-line direction VL and measure a distance d to the subject.

In the present embodiment, the sensor 14 is fixed at a predetermined position in the work cell where the workpiece W can be within the field of view of the sensor 14. The sensor 14 images the workpiece W and acquires image data of the workpiece W as detection data DD. The detection data DD will be described in detail below.

As illustrated in FIG. 1, a robot coordinate system (or a world coordinate system) C1 and a tool coordinate system C2 are set for the robot 12. The robot coordinate system C1 is a control coordinate system for automatically controlling operations of movable components of the robot 12 (the swivel body 20, the lower arm 22, the upper arm 24, the wrist 26, and the wrist flange 26b). In the present embodiment, the robot coordinate system C1 is set for the robot base 18 such that an origin thereof is arranged at the center of the robot base 18 and a z-axis thereof matches the rotation axis of the swivel body 20.

In contrast, the tool coordinate system C2 is set for the end effector 28 and defines the position of the end effector 28 in the robot coordinate system C1. In the present embodiment, the tool coordinate system C2 is set for the end effector 28 such that an origin thereof is arranged at the intermediate position between the plurality of claw parts 28b, an x-axis direction thereof is parallel to the opening and closing direction of the claw parts 28b, and a z-axis direction thereof is parallel to the extending direction of each claw part 28b.

A sensor coordinate system C3 is also set for the sensor 14. The sensor coordinate system C3 defines the position (i.e., the visual-line direction VL) of the sensor 14 in the robot coordinate system C1 and also defines the coordinates of each pixel in the image data (or, the image sensor) imaged by the sensor 14. In the present embodiment, the sensor coordinate system C3 is set for the sensor 14 such that an origin thereof is arranged at the center of the image sensor and a z-axis direction thereof is parallel to (specifically, matches) the visual-line direction VL of the sensor 14.

As illustrated in FIG. 2, the controller 16 is a computer including a processor 32, a memory 34, an I/O interface 36, a display device 38, and an input device 40. The processor 32 includes a CPU or a GPU, is communicably connected to the memory 34, the I/O interface 36, the display device 38, and the input device 40 via a bus 42, and executes arithmetic processing for achieving an operation verification function described below while communicating with these components.

The memory 34 includes a RAM or a ROM and temporarily or permanently stores various types of data. The I/O interface 36 includes, for example, an Ethernet (trade name) port, a USB port, an optical fiber connector, or an HDMI (trade name) terminal and communicates data with external devices by wire or wirelessly by a command from the processor 32. In the present embodiment, the I/O interface 36 is communicably connected to the sensor 14, and each servo motor 30.

The display device 38 includes a liquid crystal display, an organic EL display, or the like, and displays various types of data in a visually recognizable manner in accordance with a command from the processor 32. The input device 40 includes a push button, a keyboard, a mouse, a touch panel, or the like and receives input data from an operator.

When the end effector 28 is positioned at a predetermined position by the movable components of the robot 12 (the swivel body 20, the lower arm 22, the upper arm 24, the wrist 26, and the wrist flange 26b), the processor 32 first sets the tool coordinate system C2 representing the predetermined position in the robot coordinate system CL.

Then, the processor 32 generates a command for each of the servo motors 30 to arrange the end effector 28 at the position defined by the set tool coordinate system C2 and moves the end effector 28 by operating the movable components of the robot 12 in response to the command. Thus, the processor 32 can position the end effector 28 at any given position in the robot coordinate system C1. In the present description, the “position” may indicate a position and an orientation.

Next, an operation of the industrial machine 10 when the industrial machine 10 carries out a work on the workpiece W (specifically, workpiece handling work) will be described. The industrial machine 10 carries out the work on the workpiece W by executing an operation program OP created in advance. The operation program OP includes a plurality of instructions CM each of which causes the industrial machine 10 (i.e., the robot 12, the sensor 14, and the controller 16) to perform a corresponding one of a plurality of operations. Each instruction CM is described using a plurality of letters, numbers or symbols (so-called code).

In the present embodiment, the operation program OP includes a first operation program OP1 for controlling an operation of acquiring the detection data DD by the sensor 14 and a second operation program OP2 for defining a main operation process of the robot 12, the sensor 14, and the controller 16 when the workpiece handling work is carried out.

The first operation program OP1 includes an instruction CMLᵢ for causing the sensor 14 to perform an operation for detecting the detection data DD by imaging the workpiece W, and an instruction CM1ᵢ₊₁ for causing the controller 16 to perform an operation of calculating a correction amount CA for correcting the operation of the robot 12 when the workpiece handling work is carried out using the detection data DD.

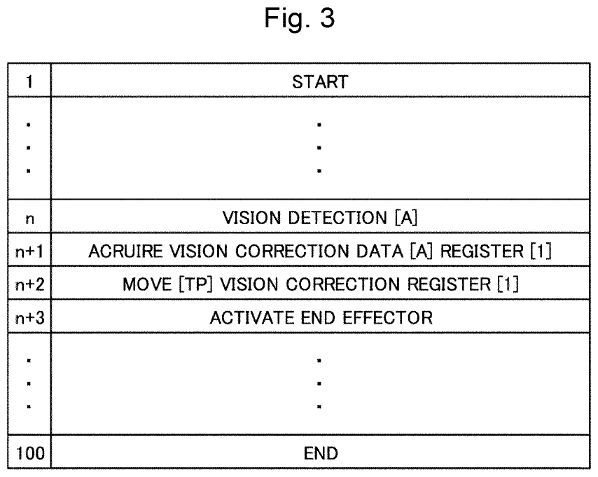

On the other hand, the second operation program OP2 includes a plurality of instructions CM2ⱼ for causing the robot 12 to perform a series of operations for the workpiece handling work based on the detection data DD detected by executing the first operation program OP1. FIG. 3 illustrates an example of the second operation program OP2.

In the example illustrated in FIG. 3, the second operation program OP2 includes various instructions CM2ⱼ (j=1, 2, 3, . . . , n, n+1, n+2, n+3, . . . , 100) in the first to 100th lines. After starting the second operation program OP2 (the instruction CM2ₗ “START” in the first line), the processor 32 of the controller 16 sequentially reads and executes the instructions CM2ⱼ in the first to 100th lines, thereby performing the series of operations for the workpiece handling work.

Hereinafter, operations of the industrial machine 10 when the instructions CM2ₙ, CM2ₙ₊₁, CM2ₙ₊₂, and CM2ₙ₊₃ in the n-th to the (n+3)-th lines in FIG. 3 are executed for the workpiece handling work will be described. When reading the instruction CM2ₙ “VISION DETECTION [A]” in the n-th line, the processor 32 causes the sensor 14 to perform an operation of detecting the detection data DD.

Here, the code of the character string “VISION DETECTION” in the instruction CM2ₙ is an instruction code for starting detection of the detection data DD, and the code “[A]” is an identification code for identifying the type of the first operation program OP1 for detecting the detection data DD.

Here, as the first operation program OP1, a plurality of first operation programs OP1_{A}, OP1_{B}, OP1_{C}, . . . each corresponding to the type of the sensor 14 to be used or an operation to be performed by the sensor 14 can be prepared in advance. The identification code “A” is a code for identifying the first operation program OP1_{A} of the type A among the plurality of first operation programs OP1.

When reading the instruction CM2ₙ, the processor 32 executes the first operation program OP1_{A} and issues a detection command to the sensor 14 in accordance with the instruction CMLᵢ defined in the first operation program OP1_{A}. In response to the detection command, the sensor 14 images the workpiece W and detects the detection data DD.

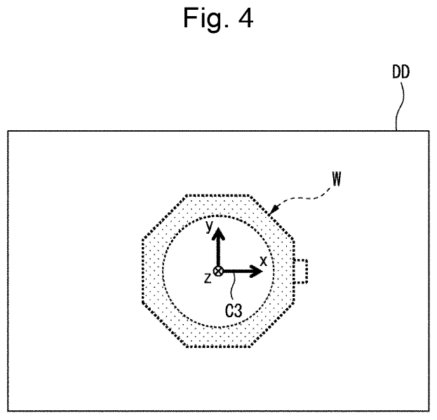

FIG. 4 illustrates an example of the detection data DD. In the example illustrated in FIG. 4, the detection data DD is three-dimensional image data, and visual features (surface, edge, hole, apex, or the like) of the workpiece W are displayed as a three-dimensional point cloud. Each point constituting the three-dimensional point cloud has information of the above-described distance d and can be represented as three-dimensional coordinates (X, Y, Z) in the sensor coordinate system C3.

The processor 32 of the controller 16 acquires the detection data DD from the sensor 14 through the I/O interface 36. That is, in the present embodiment, the processor 32 functions as a detection data acquiring unit 44 (FIG. 2) to acquire the detection data DD detected by the sensor 14.

Next, the processor 32 reads the instruction CM2ₙ₊₁ “ACQUIRE VISION CORRECTION DATA [A] REGISTER [1]” (first instruction) in the (n+1)-th line. Here, in the instruction CM2ₙ₊₁, the code “ACQUIRE VISION CORRECTION DATA [A]” is an instruction code for causing the processor 32 to execute the first operation program OP1_{A} of the type A and to perform an operation of calculating the correction amount CA using the detection data DD obtained by executing the instruction CM2ₙ in the n-th line. The code “REGISTER [1]” is a register code representing a data storage location of the calculated correction amount CA.

When reading the instruction CM2ₙ₊₁, the processor 32 executes the first operation program OP1_{A} and calculates the correction amount CA using the detection data DD in accordance with the instruction CM1ᵢ₊₁ defined in the first operation program OP1_{A}. Specifically, the processor 32 detects a profile shape PF_{W} of the workpiece W in the detection data DD illustrated in FIG. 4 by collating the profile shape PF_{W} with a reference profile shape PF₀ taught in advance and matches the detected profile shape PF_{W} with a workpiece model WM (e.g., three-dimensional CAD data) modeling the workpiece W in the sensor coordinate system C3. The reference profile shape PF₀ is taught in advance using, for example, the workpiece model WM for detection of the profile shape PF_{W} of the workpiece W in the detection data DD.

Then, the processor 32 acquires position data PDs representing the position of the workpiece model WM matching the profile shape PF_{W} in the sensor coordinate system C3 (specifically, coordinates (X, Y, Z, W, P, R) representing the position and the orientation). Then, the processor 32 converts the acquired position data PDs into position data PD_{R} in the robot coordinate system C1 using a transformation matrix (e.g., a homogeneous transformation matrix) representing a known positional relationship between the robot coordinate system C1 and the sensor coordinate system C3.

The position data PD_{R} indicates the actual position of the workpiece W detected by the sensor 14 in the robot coordinate system C1. Then, based on the position data PD_{R}, the processor 32 calculates, as the correction amount CA, a shift amount by which the position of the end effector 28 determined by the robot 12 when the workpiece handling work is carried out is shifted from a teaching position TP taught in advance. The teaching position TP is represented as coordinates in the robot coordinate system C1 and is taught to the robot 12 in advance as a target position for positioning the end effector 28 (i.e., setting the tool coordinate system C2) when carrying out the workpiece handling work.

Then, the processor 32 stores the calculated correction amount CA in a memory region RG1 designated by the register code “REGISTER [1]”. The memory region RG1 may be provided in a register in the processor 32 or in the memory 34. In this way, the processor 32 calculates the correction amount CA and stores the correction amount CA in the memory region RG1 by executing the instruction CM2ₙ₊₁.

Next, the processor 32 reads the instruction CM2ₙ₊₂ “MOVE [TP] VISION CORRECTION REGISTER [1]” (second instruction) in the (n+2)-th line. Here, in the instruction CM2ₙ₊₂, a code “MOVE [TP]” is an instruction code for causing the robot 12 to perform an operation of moving the end effector 28 to the teaching position TP.

The code “VISION CORRECTION REGISTER [1]” is an instruction code for causing the robot 12 to perform an operation of correcting the position of the end effector 28 in accordance with the correction amount CA stored in the memory region RG1 designated by “REGISTER [1]” when the robot 12 moves the end effector 28 to the teaching position TP.

When reading the instruction CM2ₙ₊₂, the processor 32 transmits a command to each servo motor 30 of the robot 12 and corrects the operation of the robot 12 so that the robot 12 moves the end effector 28 to a position TP′ shifted from the teaching position TP by the correction amount CA. In this way, the processor 32 controls the operation in which the robot 12 moves the end effector 28 based on the detection data DD.

Next, the processor 32 reads the instruction CM2ₙ₊₃ “ACTIVATE END EFFECTOR” in the (n+3)-th line. The instruction CM2ₙ₊₃ is an instruction code for activating the end effector 28 and causing the robot 12 to perform an operation of gripping the workpiece W with the end effector 28.

Thus, when reading the instruction CM2ₙ₊₃, the processor 32 operates the end effector 28 to grip the workpiece W with the end effector 28.

The processor 32 repeatedly executes the instructions CM2ₙ, CM2ₙ₊₁, CM2ₙ₊₂, and CM2ₙ₊₃ in the n-th to (n+3)-th lines on a plurality of workpieces W and causes the sensor 14 to detect detection data DD₁, DD₂, DD₃, . . . , DDₘ of the respective workpieces W in accordance with the first operation program OP1_{A}, and the processor 32 functions as the detection data acquiring unit 44 to acquire, as history data HS, the detection data DDₘ (m=1, 2, 3, . . . ) detected when executing the first operation program OP1_{A}.

Along with the detection data DDₘ acquired from the sensor 14, a detection time t indicating the time at which the detection data DDₘ is detected, position data PD_{R_m} obtained using the detection data DDₘ, identification information i (e.g., the identification code “A”) for identifying the used first operation program OP1_{A}, and detection result information RSₘ of the detection data DDₘ are stored in chronological order as a detection data set DSₘ in the history data HS.

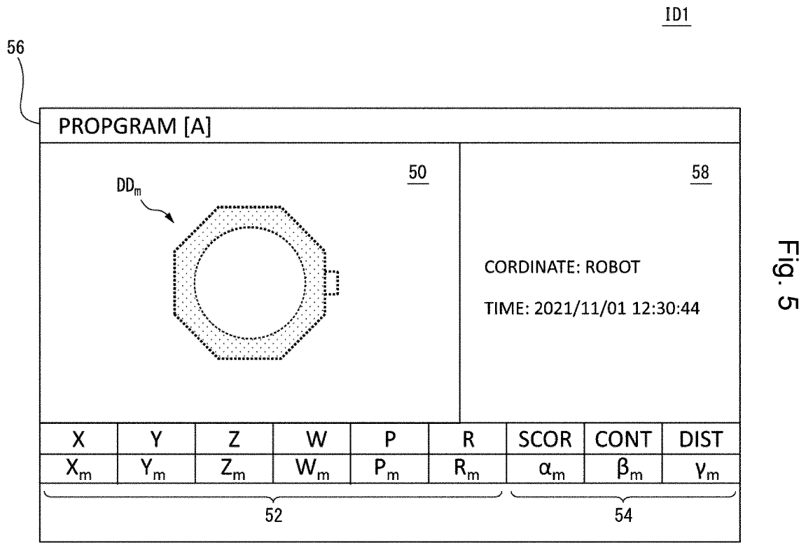

Examples of the detection result information RSₘ include a score am representing a degree of matching between the profile shape PF_{W} of the workpiece W detected from the detection data DDₘ and the reference profile shape PF₀ taught in advance, a contrast βₘ of the image of the detection data DDₘ, and a distortion γₘ of the profile shape PF_{W} in the detection data DDₘ with respect to the reference profile shape PF₀. FIG. 5 illustrates an example of image data obtained by converting the detection data set DSₘ (the detection data DDₘ, the detection time t, the position data PD_{R_m}, the identification information i, the score am, the contrast βₘ, and the distortion γₘ) stored in the history data HS into an image.

FIG. 5 illustrates setting image data ID1 for setting an operation parameter PR of the industrial machine 10 based on the detection data set DSₘ. The setting of the operation parameter PR will be described below. In the example illustrated in FIG. 5, the setting image data ID1 includes a detection data image region 50 for displaying the three-dimensional point cloud image of the detection data DDₘ, a position data image region 52 for displaying the position data PD_{R_m} (Xₘ, Yₘ, Zₘ, Wₘ, Pₘ, and Rₘ), a detection result image region 54 for displaying the detection result information RSₘ (specifically, the score αₘ, the contrast βₘ, and the distortion γₘ), an identification information image region 56 for displaying the identification information of the first operation program OP1_{A} “PROGRAM [A]”, and a data information image region 58 for displaying various types of information of the detection data DDₘ.

Note that, in the example illustrated in FIG. 5, the detection time t “2021/11/01 12:30:44” of the detection data DDₘ and the coordinate system used for acquisition of the position data PD_{R_m} (in the present embodiment, the robot coordinate system C1 “ROBOT”) are displayed in the data information image region 58. The processor 32 can generate the setting image data ID1 for displaying the detection data DDₘ stored in the history data HS and display the setting image data ID1 on the display device 38.

Here, in the present embodiment, the processor 32 associates the executed instruction CM2ⱼ of the second operation program OP2 and the detection data DDₘ used for control of the operation performed by the instruction CM2ⱼ with each other. Specifically, when acquiring the detection data DDₘ by executing the instruction CM2₁ in the n-th line, the processor 32 acquires specifying information SIₘ for specifying the detection data DDₘ.

Examples of the specifying information SIₘ include the above-described detection time t and the identification information i. Based on the detection time t and the identification information i included in the specifying information SIₘ, it is possible to specify which type of the first operation program OP1 is used to detect the detection data DDₘ and when the detection data DDₘ is detected. Then, when calculating a correction amount CAₘ using the detection data DDₘ by executing the instruction CM2ₙ₊₁ in the (n+1)-th line, the processor 32 attaches the specifying information SIₘ to the obtained correction amount CAₘ and stores them in the memory region RG1.

The specifying information SIₘ (the detection time t, the identification information i, etc.) is information for associating the detection data DDₘ used at the time of calculation of the correction amount CAₘ with the correction amount CAₘ in the data, and the processor 32 can search for the detection data DDₘ used for calculation of the correction amount CAₘ with reference to the correction amount CAₘ from the history data HS using the specifying information SIₘ.

On the other hand, the instruction CM2ₙ₊₁ in the (n+1)-th line (first instruction) and the instruction CM2ₙ₊₂ in the (n+2)-th line (second instruction) are associated with the correction amount CAₘ via the above-described register code “REGISTER [1]”. In this way, the processor 32 can associate the instruction CM2ⱼ (specifically, the instructions CM2ₙ₊₁ and CM2ₙ₊₂) and the detection data DDₘ with each other in the data via the register code, the correction amount CAₘ, and the specifying information SIₘ by attaching the specifying information SIₘ to the calculated correction amount CAₘ. That is, the processor 32 functions as an association generating unit 46 (FIG. 2) to associate the instruction CM2ⱼ and the detection data DDₘ with each other.

Here, when the instructions CM2ₙ, CM2ₙ₊₁, CM2ₙ₊₂, and CM2ₙ₊₃ in the n-th to (n+3)-th lines defined in the second operation program OP2 are executed and an operation of causing the end effector 28 to grip the workpiece W is performed, a malfunction may occur in the operation of the industrial machine 10, such as the end effector 28 failing to appropriately grip the workpiece W.

In the present embodiment, since the processor 32 functions as the detection data acquiring unit 44 and the association generating unit 46 to associate the instruction CM2ⱼ of the second operation program OP2 and the detection data DDₘ with each other, it is possible to easily verify the cause of the malfunction in the operation of the industrial machine 10. That is, the detection data acquiring unit 44 and the association generating unit 46 constitute a device 60 (FIG. 2) for verifying the operation of the industrial machine 10. The device 60 (the detection data acquiring unit 44 and the association generating unit 46) is, for example, a functional module implemented by the operation program OP executed by the processor 32.

As described above, the device 60 for verifying the operation of the industrial machine 10 that controls the operation based on the detection data DDₘ includes the detection data acquiring unit 44 that acquires the detection data DDₘ detected by the sensor 14 when the operation program OP (OP1, OP2) is executed, and the association generating unit 44 that associates the executed instruction CM2ⱼ (specifically, the instructions CM2ₙ₊₁ and CM2ₙ₊₂) and the detection data DDₘ used for control of the operation performed by the instruction CM2ⱼ with each other.

According to the device 60, the operator can search for the detection data DDₘ used for control of the operation causing the malfunction from the instruction CM2ⱼ for performing the operation. As a result, it is possible to facilitate the work of verifying the cause of the malfunction in the operation of the industrial machine 10 by checking whether or not the detection data DDₘ is erroneously detected.

Moreover, in the present embodiment, the detection data acquiring unit 44 acquires the detection data DDₘ as the history data HS in which the detection data DDₘ detected when the operation program OP (OP1, OP2) is executed is stored in chronological order. According to this configuration, the operator can accumulate the plurality of pieces of detection data DDₘ acquired at respective times when the workpiece handling work is carried out on the plurality of workpieces W as the history data HS in a searchable format.

Furthermore, in the present embodiment, the operation program OP includes the first operation program OP1_{A} including the instruction CM1ᵢ for causing the sensor 14 to perform the operation of detecting the detection data DD by imaging the workpiece W, and the second operation program OP2 including the instruction CM2ⱼ (e.g., the instruction CM2ₙ₊₂) for causing the robot 12 to perform the operation for the workpiece handling work based on the detection data DDₘ detected by executing the first operation program OP1_{A}.

The association generating unit 46 associates the instruction CM2ⱼ included in the second operation program OP2 and the detection data DDₘ used for control of the operation performed by the instruction CM2ⱼ with each other. According to this configuration, the operator can search for the detection data DDₘ used for control of the operation causing the malfunction from the instruction CM2ⱼ (e.g., the instruction CM2ₙ₊₁ or CM2ₙ₊₂) defined in the second operation program OP2 and to execute operation verification for the cause of the malfunction based on the detection data DDₘ.

In addition, in the present embodiment, the operation program OP (specifically, the second operation program OP2) includes the first instruction CM2ₙ₊₁ for calculating the correction amount CA for correcting the operation of the industrial machine 10 (specifically, the robot 12) when the workpiece handling work is carried out using the detection data DDₘ, and the second instruction CM2ₙ₊₂ for correcting the operation of the industrial machine 10 (the robot 12) in accordance with the correction amount CAₘ calculated by executing the first instruction CM2ₙ₊₁. Then, the association generating unit 46 associates the first instruction CM2ₙ₊₁ and the second instruction CM2ₙ₊₂ with the detection data DDₘ via the correction amount CAₘ.

More specifically, the first instruction CM2ₙ₊₁ and the second instruction CM2ₙ₊₂ include the register code “REGISTER [1]” representing a data storage location (i.e., the memory region RG1) of the calculated correction amount CAₘ. Then, the association generating unit 46 acquires the specifying information SIₘ of the detection data DDₘ used for calculation of the correction amount CAₘ and associates the first instruction CM2ₙ₊₁ and the second instruction CM2ₙ₊₂ with the detection data DDₘ via the register code, the correction amount CAₘ, and the specifying information SIₘ.

According to this configuration, when the correction amount CAₘ is acquired, the correction amount CAₘ and the detection data DDₘ can be automatically associated with each other via the specifying information SIₘ. Thus, the instruction CM2ₙ₊₁ or CM2ₙ₊₂ and the detection data DDₘ can be automatically associated with each other via the register code, the correction amount CAₘ, and the specifying information SIₘ. As a result, the operator can automatically search for the detection data DDₘ from the instruction CM2ₙ₊₁ or CM2ₙ₊₂, so that the operation verification of the industrial machine 10 can be executed more easily.

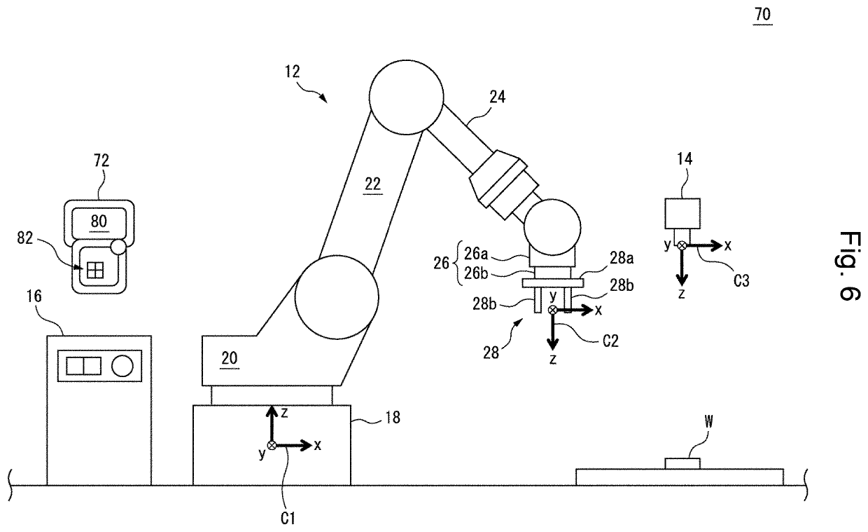

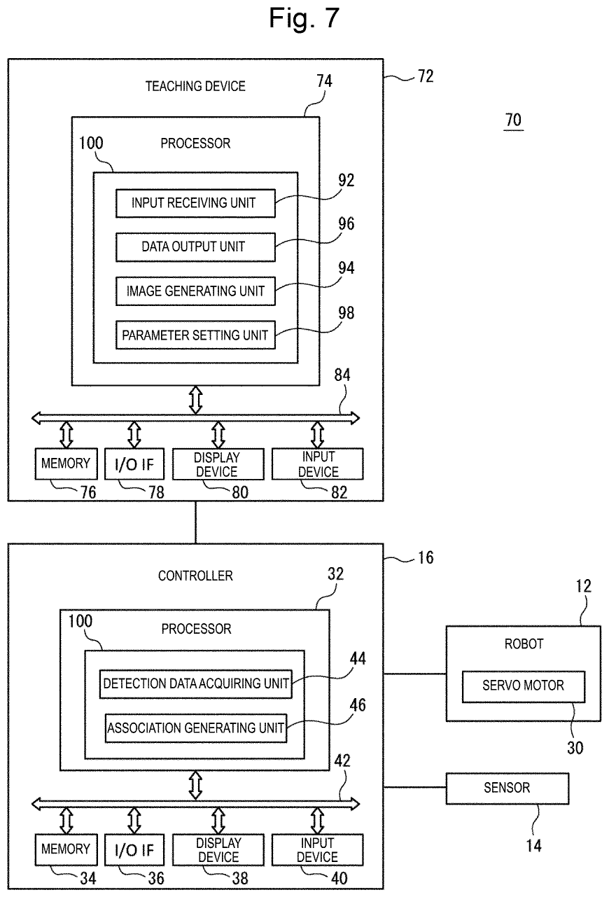

Next, an industrial machine 70 according to another embodiment will be described with reference to FIG. 6 and FIG. 7. The industrial machine 70 further includes a teaching device 72. In this point, the industrial machine 70 is different from the above-described industrial machine 10. The teaching device 72 teaches the robot 12 an operation for carrying out a work on the workpiece W (in the present embodiment, the workpiece handling work).

Specifically, the teaching device 72 is a portable computer such as a teaching pendant or a tablet-type terminal device and includes a processor 74, a memory 76, an I/O interface 78, a display device 80, and an input device 82. Note that since the configurations of the processor 74, the memory 76, the I/O interface 78, the display device 80, and the input device 82 are the same as those of the above-described processor 32, memory 34, I/O interface 36, display device 38, and input device 40, overlapping descriptions are omitted.

The processor 74 is communicably connected to the memory 76, the I/O interface 78, the display device 80, and the input device 82 via a bus 84 and executes arithmetic processing for achieving a teaching function while communicating with these components. The I/O interface 78 is communicably connected to the I/O interface 36 of the controller 16. Note that the display device 80 and the input device 82 may be integrated into the housing of the teaching device 72 or may be externally attached separately from the housing of the teaching device 72.

The processor 74 is configured to transmit a command to the servo motors 30 of the robot 12 via the controller 16 in response to input data input into the input device 82 and to allow the robot 12 to perform a jogging operation in accordance with the command. The operator operates the input device 82 to teach the robot 12 an operation for the workpiece handling work (e.g., an operation of positioning the end effector 28 at the teaching position TP). The processor 74 generates the operation program OP (e.g., the second operation program OP2) based on data such as the teaching position TP obtained as a result of the teaching.

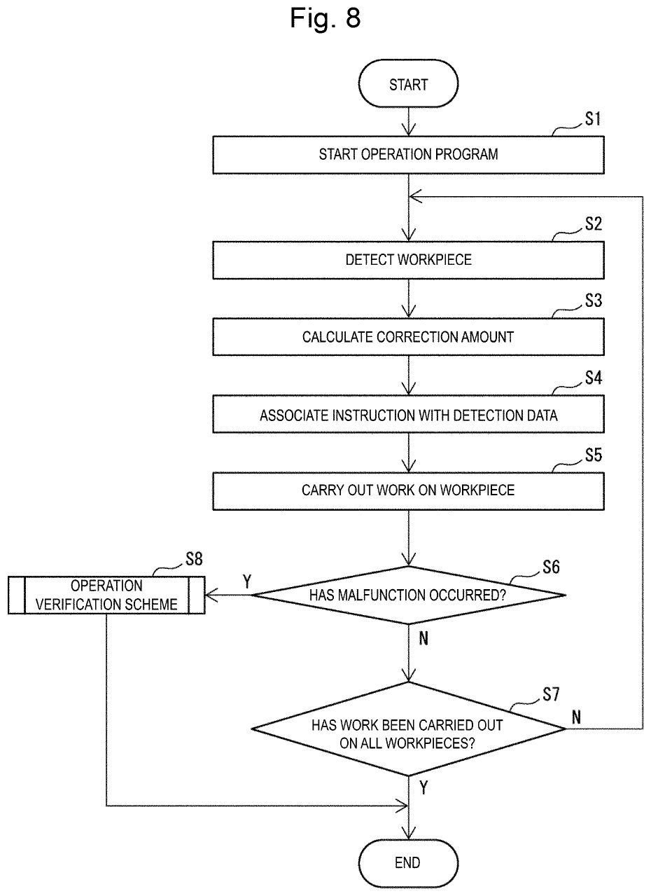

Next, an operation of the industrial machine 70 will be described with reference to FIG. 8. A process illustrated in FIG. 8 starts when the processor 32 of the controller 16 receives a work start command from the operator, the operation program OP (the second operation program OP2), or a host controller. In step S1, the processor 32 of the controller 16 starts the operation program OP. Specifically, the processor 32 reads the instruction CM2₁ “START” in the first line of the second operation program OP2 and starts the second operation program OP2.

In step S2, the processor 32 causes the sensor 14 to operate and detect the workpiece W.

Specifically, the processor 32 reads the instruction CM2ₙ “VISION DETECTION [A]” in the n-th line of the second operation program OP2 as described above and executes the first operation program OP1_{A} to cause the sensor 14 to detect the detection data DDₘ obtained by imaging the workpiece W.

The processor 32 functions as the detection data acquiring unit 44 to acquire the detection data DDₘ from the sensor 14, also acquire the above-described detection time t, position data PD_{R_m}, identification information i, and detection result information RSₘ (the score αₘ, the contrast βₘ, and the distortion γₘ), store them in the history data HS as the detection data set DSₘ, and save them in the memory 34.

Note that when acquiring the detection data DDₘ in step S2, the processor 32 may determine whether or not the score αₘ of the detection data DDₘ is smaller than a predetermined threshold value α₀ (αₘ<α₀). Then, when αₘ<α₀ is satisfied, the processor 32 may invalidate the acquired detection data DDₘ, cause the sensor 14 to image the workpiece W again, and acquire new detection data DD_{m_2}. The threshold value α₀ is predetermined by the operator as a lower limit value of the score α for validating the detected detection data DDₘ.

In step S3, the processor 32 calculates the correction amount CAₘ. Specifically, the processor 32 reads the instruction CM2ₙ₊₁ “ACQUIRE VISION CORRECTION DATA [A] REGISTER [1]” in the (n+1)-th line of the second operation program OP2 as described above, acquires the position data PD_{R_m} of the workpiece W in the robot coordinate system C1 based on the detection data DDₘ, and calculates the correction amount CAₘ for correcting an operation of causing the robot 12 to move the end effector 28 to the teaching position TP based on the position data PD_{R_m}.

In step S4, the processor 32 associates the instruction CM2ⱼ and the detection data DDₘ with each other. Specifically, the processor 32 functions as the association generating unit 46, and as described above, attaches the specifying information SIₘ (the detection time t, the identification information i, etc.) to the correction amount CAₘ calculated in a most recent step S3, and stores the specifying information SIₘ as well as the correction amount CAₘ in the memory region RG1. Thus, the instruction CM2ⱼ (e.g., the instructions CM2ₙ₊₁ and CM2ₙ₊₂) and the detection data DDₘ are associated with each other via the register code, the correction amount CAₘ, and the specifying information SIₘ.

When the size of the memory region RG1 is small (e.g., when the memory region RG1 is provided in the register in the processor 32), the processor 32 may update a correction amount CAₘ₋₁ and specifying information SIₘ₋₁ previously stored in the memory region RG1 to a newly calculated correction amount CAₘ and specifying information SIₘ. That is, in this case, only the latest correction amount CAₘ and specifying information SIₘ are stored in the memory region RG1.

In step S5, the processor 32 carries out the work on the workpiece W. Specifically, as described above, the processor 32 reads the instruction CM2ₙ₊₂ “MOVE [TP] VISION CORRECTION REGISTER [1]” in the (n+2)-th line of the second operation program OP2 and moves the end effector 28 to the position TP′ shifted from the teaching position TP by the correction amount CA. Next, the processor 32 reads the instruction CM2ₙ₊₃ “ACTIVATE END EFFECTOR” in the (n+3)-th line and operates the end effector 28 to grip the workpiece W with the end effector 28.

In step S6, the processor 32 determines whether or not a malfunction has occurred in the operation of the industrial machine 70. As an example, the operator visually checks whether or not the end effector 28 is appropriately gripping the workpiece W after step S5. When the end effector 28 has failed to appropriately grip the workpiece W, the operator operates the input device 82 of the teaching device 72 (or the input device 40 of the controller 16) to provide the processor 32 with an input IP1 indicating that the malfunction has occurred in the operation of the industrial machine 70.

When receiving the input IP1, the processor 32 of the controller 16 determines YES and proceeds to step S8. When not receiving the input IP1 (when receiving an input IP1′ indicating that no malfunction has occurred in the operation of the industrial machine 70), the processor 32 determines NO and proceeds to step S7.

In step S7, the processor 32 determines whether or not the work (workpiece handling work) has been completed for all of the workpieces W. For example, the processor 32 can determine whether or not all of the work has ended based on the second operation program OP2. The processor 32 determines YES when all of the work has ended and ends the process illustrated in FIG. 8, whereas the processor 32 determines NO when the work has not been carried out on all of the workpieces W and returns to step S2. In this way, the processor 32 repeatedly performs steps S1 to S7 until YES is determined in step S6 or S7 and sequentially performs the series of operations of steps S1 to S7 for each of the plurality of workpieces W.

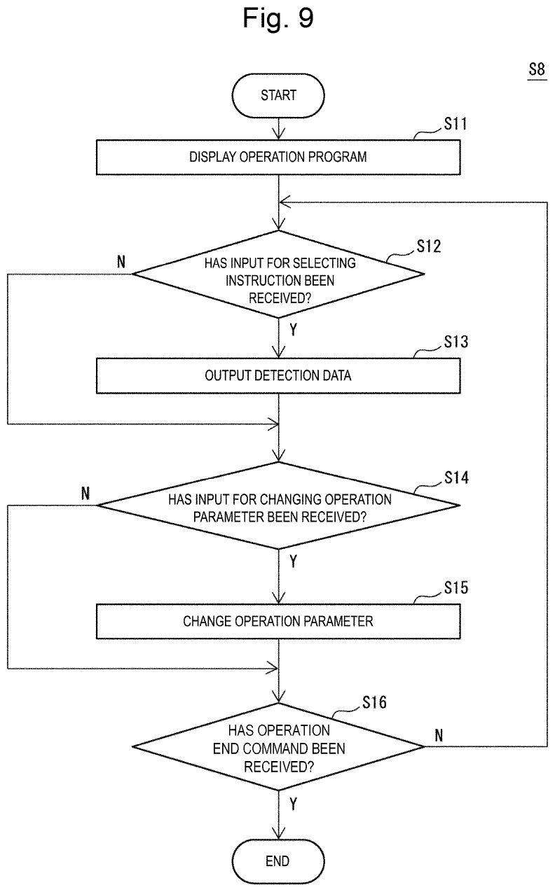

On the other hand, when determining YES in step S6, the processor 74 of the teaching device 72 executes an operation verification scheme in step S8. Step S8 will be described with reference to FIG. 9. In step S11, the processor 74 displays the operation program OP on the display device 80.

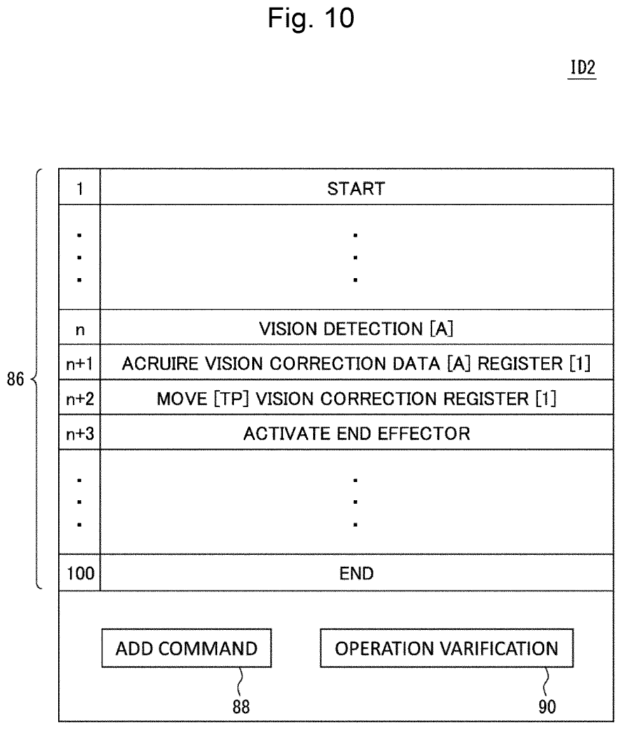

Specifically, the processor 74 generates operation verification image data ID2 in which each instruction CM2ⱼ of the second operation program OP2 is displayed and displays the operation verification image data ID2 on the display device 80. An example of the operation verification image data ID2 is illustrated in FIG. 10. In the example illustrated in FIG. 10, the operation verification image data ID2 includes a program image region 86 for displaying the instructions CM2ⱼ of the second operation program OP2, an instruction addition button image 88, and an operation verification button image 90.

In the operation verification image data ID2, the operator can operate the input device 82 to select one of the instructions CM2ⱼ displayed in the program image region 86 by clicking on the image. The instruction addition button image 88 is for editing the instruction CM2ⱼ selected in the program image region 86 by adding a new code to the instruction CM2ⱼ or deleting or changing the code described in the instruction CM2ⱼ.

On the other hand, the operation verification button image 90 is for verifying the operation performed by the instruction CM2ⱼ selected in the program image region 86. For example, it is assumed that the operator has recognized a malfunction of the end effector 28 poorly gripping the workpiece W in the above-described step S6.

In this case, for example, the operator can estimate that the malfunction is caused by the operation of the instruction CM2ₙ₊₂ “MOVE [TP] VISION CORRECTION REGISTER [1]” immediately before the instruction CM2ₙ₊₃ “ACTIVATE END EFFECTOR” for causing the end effector 28 to grip the workpiece W among the instructions CM2ⱼ of the second operation program OP2.

In order to verify the operation by the instruction CM2ₙ₊₂, the operator operates the input device 82 to select the instruction CM2ₙ₊₂ by clicking, on the image, “n+2” or the code “MOVE [TP] VISION CORRECTION REGISTER [1]” representing the instruction CM2ₙ₊₂ in the program image region 86 and then clicks, on the image, the operation verification button image 90.

The processor 74 receives an input IP2 for selecting one instruction CM2ₙ₊₂ and operating the operation verification button image 90 through the operation verification image data ID2. In this way, in the present embodiment, the processor 74 functions as an input receiving unit 92 (FIG. 7) to receive the input IP2 for selecting the one instruction CM2ₙ₊₂.

In step S12, the processor 74 determines whether or not the above-described input IP2 has been received. When receiving the input IP2, the processor 74 determines YES and proceeds to step S13. When not receiving the input IP2, the processor 74 determines NO and proceeds to step S14.

In step S13, the processor 74 outputs the detection data DDₘ associated with the instruction CM2n+2 selected by the input IP2 received in step S12. Specifically, the processor 74 refers to the register code “REGISTER [1]” of the instruction CM2ₙ₊₂ and, in cooperation with the controller 16, searches for and acquires the latest correction amount CAₘ stored in the memory region RG1 designated by the register code. Next, the processor 74 refers to the specifying information SIₘ (the detection time t and the identification information i) attached to the correction amount CAₘ searched for and, in cooperation with the controller 16, searches for the detection data DDₘ specified by the specifying information SIₘ from the history data HS.

As an example, the processor 74 may transmit a command to the controller 16 to cause the processor 32 of the controller 16 to search for the correction amount CAₘ and the detection data DDₘ stored in the controller 16 (e.g., the memory 34) and acquire, from the controller 16, the correction amount CAₘ and the detection data DDₘ searched for.

As another example, the processor 74 may acquire the correction amount CAₘ and the history data HS from the controller 16 and store them in the memory 76 of the teaching device 72. Then, the processor 74 may search for the detection data DDₘ specified by the specifying information SIₘ of the acquired correction amount CAₘ in the history data HS stored in the memory 76.

As described above, since the instruction CM2ⱼ and the detection data DDₘ are associated with each other by the association generating unit 46, the processor 74 can automatically search for the detection data DDₘ associated with the instruction CM2ₙ₊₂ in response to the input IP2 for selecting the instruction CM2ₙ₊₂. Note that, in the present embodiment, as described above, the detection data DDₘ is stored in the history data HS as the detection data set DSₘ together with the detection time t, the position data PD_{R_m}, the identification information i, and the detection result information RSₘ. Thus, in step S13, the processor 74 acquires the detection data set DSₘ including the searched detection data DDₘ.

The processor 32 outputs the acquired detection data set DSₘ as image data. Specifically, the processor 74 generates the setting image data ID1 (FIG. 5) in which the detection data set DSₘ is displayed. That is, in the present embodiment, the processor 74 functions as an image generating unit 94 (FIG. 7) to generate the setting image data ID1.

At this time, the processor 74 may generate the setting image data ID1 by executing the above-described first operation program OP1_{A}. In this case, the first operation program OP1_{A} further includes an instruction CM1ᵢ₊₂ for causing the processor 74 to perform an operation of generating the setting image data ID1.

When generating the setting image data ID1, the processor 74 outputs the acquired detection data set DSₘ to the function of the image generating unit 94 (e.g., loads the acquired detection data set DSₘ into the first operation program OP1_{A}) and generates the setting image data ID1 in which the image data of the detection data set DSₘ (i.e., the detection data DDₘ, the detection time t, the position data PD_{R_m}, the identification information i, the score αₘ, the contrast βₘ, and the distortion γₘ) is displayed.

As described above, in the present embodiment, the processor 74 functions as a data output unit 96 (FIG. 7) to output the detection data DDₘ (in the present embodiment, the detection data set DSₘ). Thus, the processor 74 searches for and outputs the detection data DDₘ associated with the instruction CM2ₙ₊₂ selected by the input IP2 and generates the setting image data ID1 illustrated in FIG. 5. The processor 74 causes the display device 80 to display the generated setting image data ID1.

In step S14, the processor 74 determines whether or not an input IP3 for changing an operation parameter PR₀ of the industrial machine 70 has been received. Examples of the operation parameter PR₀ include the above-described reference profile shape PF₀ and the threshold value α₀ of the score α. The operator can adjust the preset operation parameter PR₀ (the reference profile shape PF₀, the threshold value α₀, or the like) by operating the input device 82 while visually recognizing the setting image data ID1 displayed on the display device 80.

The processor 74 functions as the input receiving unit 92 to receive the input IP3 for changing the operation parameter PR₀ through the setting image data ID1. When receiving the input IP3, the processor 74 determines YES and proceeds to step S15. When not receiving the input IP3, the processor 74 determines NO and proceeds to step S16.

In step S15, the processor 74 changes the operation parameter PR₀. Specifically, the processor 74 changes the preset operation parameter PR₀ (the profile shape PF₀, the threshold value α₀, etc.) to a new operation parameter PR₁ in response to the input IP3 and sets a new operation parameter PR₁. In this manner, in the present embodiment, the processor 74 functions as a parameter setting unit 98 (FIG. 7) that sets the operation parameter PR.

In step S16, the processor 74 determines whether or not an operation end command has been received from the operator, the operation program OP (the second operation program OP2), or the host controller. The processor 74 determines YES and ends step S8 when receiving the operation end command and thus ends the process in FIG. 8. On the other hand, when receiving no operation end command, the processor 74 determines NO and returns to step S12.

As described above, in the present embodiment, the processor 32 of the controller 16 functions as the detection data acquiring unit 44 and the association generating unit 46, while the processor 74 of the teaching device 72 functions as the input receiving unit 92, the image generating unit 94, the data output unit 96, and the parameter setting unit 98, and the controller 16 and the teaching device 72 cooperate with each other to verify the operation of the industrial machine 70. Thus, the detection data acquiring unit 44, the association generating unit 46, the input receiving unit 92, the image generating unit 94, the data output unit 96, and the parameter setting unit 98 constitute a device 100 for verifying the operation of the industrial machine 70.

In the present embodiment, the device 100 includes the input receiving unit 92 that receives the input IP2 for selecting the one instruction CM2ₙ₊₂, and the data output unit 96 that outputs the detection data DDₘ associated with the one instruction CM2ₙ₊₂ by the association generating unit 46 in response to the received input IP2.

According to this configuration, the operator can automatically acquire the detection data DDₘ used for control of the operation performed by the instruction CM2ₙ₊₂ and visually check the detection data DDₘ as, for example, the setting image data ID1 (FIG. 5) by only selecting the instruction CM2ₙ₊₂ estimated to be the cause of the malfunction in the operation. Accordingly, the work of verifying the operation can be largely facilitated.

Further, in the present embodiment, the device 100 further includes the image generating unit 94 that generates the setting image data ID1, and the data output unit 96 outputs the image data (three-dimensional point cloud image data) of the detection data DDₘ to the image generating unit 94. Then, the image generating unit 94 generates the setting image data ID1 (FIG. 5) in which the image data of the detection data DDₘ is displayed.

According to this configuration, by visually checking the detection data DDₘ displayed as the setting image data ID1, the operator can easily check whether or not the detection data DDₘ is erroneously detected and can thus more quickly verify the cause of the malfunction in the operation of the industrial machine 70.

Moreover, in the present embodiment, the input receiving unit 92 further receives the input IP3 for changing the operation parameter PR₀ (the reference profile shape PF₀, the threshold value α₀, etc.) through the setting image data ID1, and the device 100 further includes the parameter setting unit 98 that changes the preset operation parameter PR₀ in response to the input IP3.

According to this configuration, for example, when the malfunction in the operation of the industrial machine 70 is caused by erroneous detection of the detection data DDₘ, the operator can adjust the operation parameter PR so that such erroneous detection does not occur. As a result, it is possible to suppress the malfunction in the operation of the industrial machine 70.

Note that, in the above-described step S12, the operator may operate the input device 82 to provide the processor 74 with the input IP2 for selecting the instruction CM2ₙ₊₁ “ACQUIRE VISION CORRECTION DATA [A] REGISTER [1]” displayed in the program image region 86. In this case as well, since the instruction CM2ₙ₊₁ and the detection data DDₘ are associated with each other via the register code “REGISTER [1]”, the correction amount CAₘ, and the specifying information SIₘ, the processor 74 can function as the data output unit 96 to search for and output the detection data DDₘ in response to the input IP2.

Note that, in the above-described step S6, the processor 32 may automatically determine whether or not the malfunction has occurred in the operation of the industrial machine 70 without receiving the input IP1 from the operator. For example, the industrial machine 70 may further include a second sensor 14′, and the processor 32 may determine whether or not the malfunction has occurred based on detection data DD′ of the second sensor 14′.

As an example, the second sensor 14′ is a force sensor (e.g., a six-axis force sensor including a plurality of strain gauges) capable of detecting a force F applied to the robot 12 and is provided at a given part (e.g., the wrist 26 or the claw parts 28b) of the robot 12. The second sensor 14′ detects the force F applied from the workpiece W to the robot 12 (the wrist 26 or the claw parts 28b) when the end effector 28 grips the workpiece W in the above-described step S5 and supplies the detection data DD′ of the force F to the controller 16.

As another example, the second sensor 14′ may be a position sensor (e.g., a proximity switch or a linear scale) that is provided at the hand base 28a of the end effector 28 and that detects a position P of the claw parts 28b. In this case, when the end effector 28 grips the workpiece W in the above-described step S5, the second sensor 14′ detects the position P of the claw parts 28b and supplies the detection data DD′ of the position P to the controller 16.

As still another example, when the end effector 28 is a robot hand including a suction part, the second sensor 14′ may be a pressure sensor capable of detecting a pressure p generated at the suction part. In this case, when the end effector 28 grips the workpiece W in the above-described step S5, the second sensor 14′ detects the pressure p of the suction part and supplies the detection data DD′ of the pressure p to the controller 16.

In step S6, the processor 32 determines whether or not a detection value δ (e.g., the value of the force F, the position P, or the pressure p) indicated by the detection data DD′ is within a predetermined allowable range [δₜₕ₁, δₕ₂] (i.e., δₜₕ₁≤δ≤δₕ₂). The threshold values δₕ₁ and δₕ₂ defining the allowable range [δₕ₁, δₕ₂] are predefined by the operator with reference to the reference detection value δ₀ (a reference force F₀, a reference position P₀, or a reference pressure ρ₀) detected by the second sensor 14′ when the end effector 28 appropriately grips the workpiece W.

The processor 32 determines NO when the detection value δ is within the allowable range [δₕ₁, δₕ₂] and determines YES when the detection value δ is outside the allowable range [δₕ₁, δₜₕ₂]. In this way, the processor 32 can automatically determine whether or not the malfunction has occurred based on the detection data DD′ of the second sensor 14′.

Note that when no malfunction such as erroneous detection is recognized as a result of checking the detection data DDₘ output in step S13, the operator may operate the input device 82 to adjust the operation program OP (i.e., the first operation program OP1_{A} or the second operation program OP2).

The processor 74 updates the operation program OP in response to an input for adjusting the operation program OP and stores the updated operation program OP in the memory 76.

In the above-described embodiments, a case has been described where the specifying information SIₘ includes the detection time t and the identification information i. However, the specifying information SIₘ may include any information capable of specifying the detection data DDₘ. For example, the specifying information SIₘ may include a detection code c uniquely assigned to the detection data DDₘ instead of the detection time t.

Specifically, when acquiring the detection data DDₘ in the above-described step S2, the processor 32 of the controller 16 assigns the unique detection code c to the detection data DDₘ and stores them as the data set DSₘ. The detection code c may be described using a plurality of letters, numbers, or symbols.

Then, in the above-described step S4, the processor 32 functions as the association generating unit 46 to attach the detection code c as the specifying information SIₘ to the correction amount CAₘ calculated in the most recent step S3. As a result, the correction amount CAₘ and the detection data DDₘ are associated with each other via the detection code c. In this case, the processor 74 of the teaching device 72 can function as the data output unit 96 in the above-described step S13 to search for the detection data DDₘ from the detection code c attached to the correction amount CAₘ.

Alternatively, the specifying information SIₘ may include an order (p stored in the history data HS instead of the detection time t. For example, in the process illustrated in FIG. 8, when step S2 is performed at the third time, the processor 32 assigns the order p, which is equal to 3, to the detection data DDₘ when the detection data DDₘ is acquired, and stores them as the data set DSₘ in the history data HS. The detection data DDₘ stored in the history data HS can be specified by the order φ.

Then, in the above-described step S4, the processor 32 functions as the association generating unit 46 to attach the order (p as the specifying information SIₘ to the correction amount CAₘ calculated in the most recent step S3. As a result, the correction amount CAₘ and the detection data DDₘ are associated with each other via the order φ. In this case as well, the processor 74 of the teaching device 72 can function as the data output unit 96 in the above-described step S13 to search for the detection data DDₘ with reference to the order φ attached to the correction amount CAₘ.

Note that the specifying information SIₘ may include the number of times N that the instruction CM2ₙ in the n-th line (i.e., step S2) or the instruction CM2ₙ₊₁ in the (n+1)-th line (i.e., step S3) is executed, instead of the above-described order φ, which is equal to 3. For example, in the process illustrated in FIG. 8, when step S2 or S3 is performed for the third time, the processor 32 acquires the number of times N, which is equal to 3, as the specifying information SIₘ and stores the number of times N as the data set DSₘ in the history data HS. The detection data DDₘ stored in the history data HS can also be specified by the number of times N, which is equal to 3. In addition, the specifying information SIₘ may further include the position data PD_{R_m} obtained using the detection data DDₘ.

Note that the plurality of workpieces W may be in the detection data DDₘ acquired in step S2 of FIG. 8. In this case, the processor 32 may sequentially perform the series of operations of steps S3 to S6 on each workpiece W in the detection data DDₘ. For example, it is assumed that a total of three workpieces W1, W2, and W3 are in the detection data DDₘ acquired in step S2.

In this case, the processor 32 performs steps S3 to S6 on the first workpiece W1 after step S2. Then, in step S6′ (not illustrated) after step S6, the processor 32 determines whether or not steps S3 to S6 have been performed on all three of the workpieces W1, W2, and W3 in the detection data DDₘ and proceeds to step S7 when determining YES.

On the other hand, when determining NO in step S6′, the processor 32 returns to step S3 and performs the series of operations of steps S3 to S6 on the second workpiece W2. In this way, the processor 32 sequentially performs the series of operations of steps S3 to S6 on the first workpiece W1, the second workpiece W2, and the third workpiece W3 in the detection data DDₘ. According to this configuration, the cycle time of the process illustrated in FIG. 8 can be reduced.

Note that, in the above-described embodiments, a case has been described where the association generating unit 46 associates the instruction CM2ⱼ and the detection data DDₘ with each other via the register code, the correction amount CAₘ, and the specifying information SIₘ. However, the present disclosure is not limited thereto, and the association generating unit 46 may associate the instruction CM2ⱼ and the detection data DDₘ with each other only via the register code.

For example, in the above-described step S4, the processor 32 functions as the association generating unit 46 to directly store the detection data DDₘ (or the data set DSₘ) acquired by functioning as the detection data acquiring unit 44 in the memory region RG1 designated by the register code included in the instruction CM2ⱼ.

Thus, the instruction CM2ⱼ and the detection data DDₘ can be associated with each other via the register code. In this case, in the above-described step S13, the processor 32 can function as the data output unit 96 to search for the detection data DDₘ stored in the memory region RG1 with reference to the register code in the instruction CM2ⱼ.

Alternatively, the association generating unit 46 can directly associate the instruction CM2ⱼ and the detection data DDₘ with each other. For example, in above-described step S4, the processor 32 may function as the association generating unit 46 to generate a link data for directly linking (e.g., hyperlinking) the instruction CM2ⱼ and the detection data DDₘ with each other in the data.

Note that, in the above-described embodiments, a case has been described where the sensor 14 is fixed at a predetermined position. However, the sensor 14 may be attached to any part of the robot 12 (e.g., the wrist 26 or the end effector 28) and moved by the robot 12.

Moreover, the process illustrated in FIG. 8 may be performed when the workpiece handling work is carried out on the workpiece W in an actual manufacturing line or may be performed to experimentally carry out the workpiece handling work in a teaching stage in which the operator teaches the operation to the robot 12 using the teaching device 72. By experimentally performing the process illustrated in FIG. 8 in the teaching stage, the operation parameter PR can be optimized in step S15 before the work in the actual production line.

Furthermore, the sensor 14 is not limited to a three-dimensional vision sensor and may be a two-dimensional camera. In this case, the industrial machine 10 or 70 may further include a distance sensor that measures the distance d from the sensor 14 to the subject. In addition, the sensor 14 may further include a processor, and the processor may execute the first operation program OP1 to image the workpiece W and calculate the correction amount CA. In this case, the processor of the sensor 14 may execute the functions of the detection data acquiring unit 44 and the association generating unit 46 (i.e., the device 60 of FIG. 2).

Note that, in the above-described embodiments, a case has been described where the end effector 28 is a robot hand that can grip the workpiece W and carries out the workpiece handling work on the workpiece W. However, the present disclosure is not limited thereto, and the end effector may be any component carrying out the work, other than the robot hand, such as a laser process head.

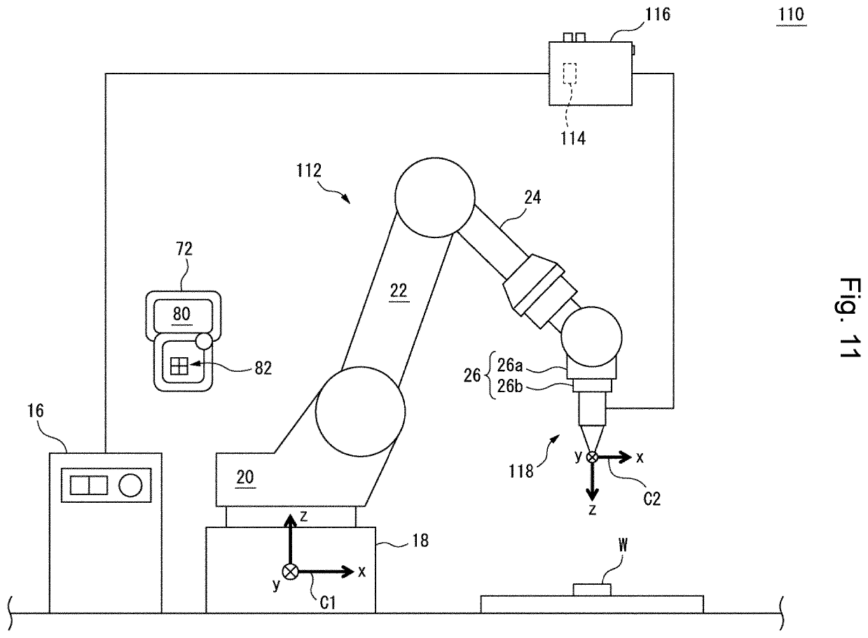

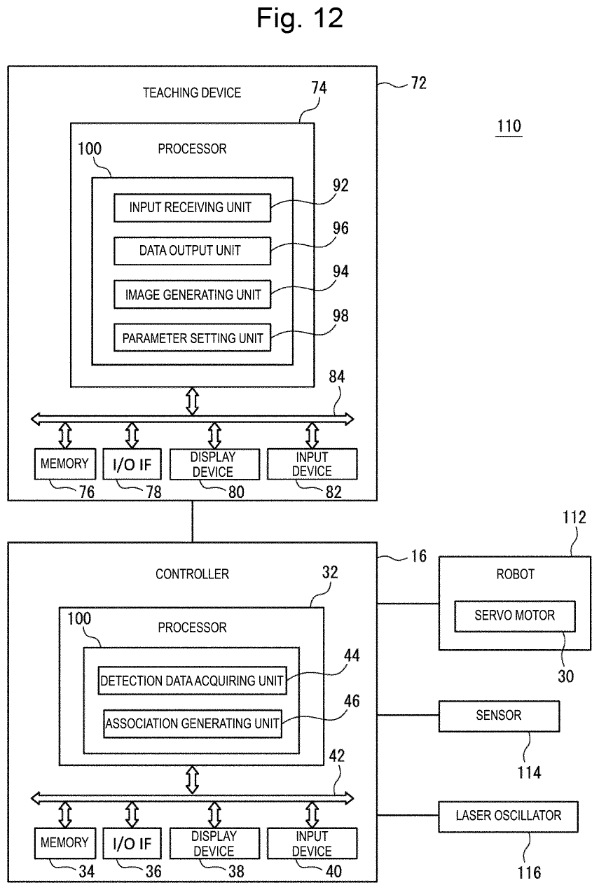

Hereinafter, such an embodiment will be described with reference to FIG. 11 and FIG. 12. An industrial machine 110 illustrated in FIG. 11 and FIG. 12 includes a robot 112, a sensor 114, a laser oscillator 116, a controller 16, and a teaching device 72. The robot 112 is different from the above-described robot 12 in that the robot 112 includes an end effector 118.

In the present embodiment, the end effector 118 is a laser process head, receives a laser beam generated by the laser oscillator 116, concentrates the laser beam, and irradiates the workpiece W with the condensed laser beam, thereby carrying out a laser process work on the workpiece W. The tool coordinate system C2 is set for the end effector 118 such that an origin thereof is arranged at a laser beam exit port of the end effector 118 and a z-axis thereof is parallel to (specifically, matches) the optical axis of the exit laser beam.

The laser oscillator 116 is a solid-state laser oscillator (e.g., a YAG laser oscillator or a fiber laser oscillator) or a gas laser oscillator (e.g., a carbon dioxide laser oscillator), generates a laser beam in response to a command from the controller 16, and supplies the laser beam to the end effector 118.

In the present embodiment, the sensor 114 includes, for example, a photoelectric sensor and detects an optical characteristic value OV of the laser beam generated by the laser oscillator 116. Examples of the optical characteristic value OV include the intensity, power, or frequency of the laser beam. The sensor 114 detects the optical characteristic value OV and supplies the optical characteristic value OV as detection data DD″ to the controller 16.

The processor 32 of the controller 16 controls operations of the robot 112 and the laser oscillator 116 in accordance with the operation program OP. In the present embodiment, the operation program OP includes a first operation program OP3 including an instruction CM3 for causing the robot 112 to move the end effector 118 and a second operation program OP4 including an instruction CM4 for causing the laser oscillator 116 to perform an operation of generating a laser beam.

The processor 32 operates the robot 112 in accordance with the first operation program OP3 to position the end effector 118 at the teaching position TP for carrying out the laser process work on the workpiece W. In addition, the processor 32 transmits a command to the laser oscillator 116 in accordance with the second operation program OP4 and causes the laser oscillator 116 to perform an operation of generating a laser beam.

The processor 32 functions as the detection data acquiring unit 44 to acquire the detection data DD″ detected by the sensor 114 when the operation program OP is executed. Then, the processor 32 controls the operations of the robot 112 and the laser oscillator 116 based on the detection data DD″.

For example, the first operation program OP3 includes an instruction CM3ₖ (first instruction) for calculating a correction amount CA″ for correcting the operation speed of the robot 112 using the detection data DD″ and an instruction CM3ₖ₊₁ (second instruction) for correcting the operation speed of the robot 112 in accordance with the correction amount CA″ calculated in accordance with the instruction CM3ₖ.

On the other hand, for example, the second operation program OP4 includes an instruction CM41 (first instruction) for calculating, using the detection data DD″, the correction amount CA″ for correcting the command value of the optical characteristic value OV to be transmitted to the laser oscillator 116 and an instruction CM4ₗ₊₁ (second instruction) for correcting the command value of the optical characteristic value OV in accordance with the correction amount CA″ calculated in accordance with the instruction CM41.

The processor 32 stores the detection data DD″ acquired from the sensor 114 when executing the operation program OP in the memory 34 as history data HS″. Then, the processor 32 functions as the association generating unit 46 to associate the executed instruction CM3ₖ, CM3ₖ₊₁, CM4ₗ, or CM4ₗ₊₁ with the detection data DD″ used for control of the operation performed by the instruction CM3ₖ, CM3ₖ₊₁, CM4ₗ, or CM4ₗ₊₁ via the correction amount CA″.

For example, the instruction CM3ₖ, CM3ₖ₊₁, CM4ₗ, or CM4ₗ₊₁ may include a register code “REGISTER [1]” representing a data storage location (i.e., the memory region RG1) for storing the calculated correction amount CA″ in the memory 34 (or the register of the processor 32).

Moreover, the processor 32 may also function as the association generating unit 46 to attach specifying information SIₘ″ (the detection time t, the identification information i, the detection code c, the order φ, the number of times N, etc.) for specifying the detection data DD″ to the calculated correction amount CA″ and store them in the memory region RG1. Accordingly, the processor 32 can associate the instruction CM3ₖ, CM3ₖ₊₁, CM4ₗ, or CM4ₗ₊₁ and the detection data DD″ with each other via the register code, the correction amount CA″, and the specifying information SIₘ″.

Note that the processor 32 may associate the instruction CM3ₖ, CM3ₖ₊₁, CM4ₗ, or CM4ₗ₊₁ and the detection data DD″ with each other only via the register code by directly storing the detection data DD″ in the memory region RG1 designated by the register code in the instruction CM3ₖ, CM3ₖ₊₁, CM4ₗ, or CM4ₗ₊₁. Alternatively, the processor 32 may directly associate the instruction CM3ₖ, CM3ₖ₊₁, CM4ₗ, or CM4ₗ₊₁ and the detection data DD″ with each other in the data using a link data or the like.

When a malfunction (e.g., a machining problem) has occurred in the operation of the industrial machine 110, the operator operates the input device 82 of the teaching device 72 to provide the processor 74 with the input IP2 for selecting the one instruction CM3ₖ, CM3ₖ₊₁, CM4ₗ, or CM4ₗ₊₁ included in the first operation program OP3 or the second operation program OP4 displayed on the display device 80.

The processor 74 functions as the input receiving unit 92 to receive the input IP2 and functions as the data output unit 96 to search for and output the detection data DD″ associated with the instruction CM3ₖ, CM3ₖ₊₁, CM4ₗ, or CM4ₗ₊₁ selected by the input IP2. At this time, the processor 74 may function as the image generating unit 94 to generate setting image data ID1″ for setting an operation parameter PR″ of the industrial machine 110 and may function as the data output unit 96 to output the detection data DD″ searched for to the image generating unit 94.

In this case, the image generating unit 94 generates the setting image data ID1″ in which the image data of the detection data DD″ is displayed. For example, the setting image data ID1″ may include a detection data image region 50″ in which a graph indicating time-varying characteristics of a plurality of pieces of the detection data DD″ (the intensities, powers, or frequencies of laser beams) acquired in chronological order is displayed.

Further, the processor 74 may function as the input receiving unit 92 to receive the input IP3 for changing the operation parameter PR″ through the setting image data ID1″ and may function as the parameter setting unit 98 to change the preset operation parameter PR″ in response to the input IP3.

As described above, in the industrial machine 110 as well, the processors 32 and 74 have the function of the device 100 (the detection data acquiring unit 44, the association generating unit 46, the input receiving unit 92, the image generating unit 94, the data output unit 96, and the parameter setting unit 98), and the device 100 allows the operator to verify the operation of the industrial machine 110.

Note that, in the above-described embodiments, a case has been described where the operation program OP includes the first operation programs OP1 and OP3 and the second operation programs OP2 and OP4. However, the present disclosure is not limited thereto, and the first operation program OP1 and the second operation program OP2 may be integrated into one operation program OP. In this case, the one operation program OP may include the instruction CM1 of the first operation program OP1 and the instruction CM2 of the second operation program OP2. The same applies to the first operation program OP3 and the second operation program OP4.

Note that, in the industrial machine 70 or 110, the processor 74 of the teaching device 72 may execute the functions of the detection data acquiring unit 44, the association generating unit 46, the input receiving unit 92, the image generating unit 94, the data output unit 96, and the parameter setting unit 98. In this case, all the functions of the device 100 are implemented in the teaching device 72.

Alternatively, in the industrial machine 70 or 110, the processor 32 of the controller 16 may execute the functions of the detection data acquiring unit 44, the association generating unit 46, the input receiving unit 92, the image generating unit 94, the data output unit 96, and the parameter setting unit 98. In this case, all the functions of the device 100 are implemented in the controller 16.

Note that, in the above-described embodiments, the robot 12 or 112 is not limited to a vertical articulated robot and may be any type of robot, such as a horizontal articulated robot or a parallel link robot. Further, the robots 12 and 112 may carry out any work other than the workpiece handling work or the laser process work. Although the present disclosure has been described through embodiments above, the embodiments described above do not limit the scope of the invention claimed in the claims.

### REFERENCE SIGNS LIST

10, 70, 110 Industrial machine
12, 112 Robot
14, 114 Sensor
16 Controller
32, 74 Processor
44 Detection data acquiring unit
46 Association generating unit
60, 100 Device
72 Teaching device
92 Input receiving unit
94 Image generating unit
96 Data output unit
98 Parameter setting unit

1. A device configured to verify an operation of an industrial machine that controls the operation based on detection data of a sensor, the device comprising:
a detection data acquiring unit configured to acquire the detection data detected by the sensor when executing an operation program including a plurality of instructions for causing the industrial machine to perform a plurality of the operations respectively; and
an association generating unit configured to associate the executed instruction and the detection data used for control of the operation performed by the executed instruction with each other.

2. The device of claim 1, wherein the detection data acquiring unit is configured to acquire the detection data as history data in which the detection data detected when executing the operation program is stored in chronological order.

3. The device of claim 1, wherein the industrial machine includes:
the sensor configured to detect a workpiece by imaging the workpiece; and
a robot configured to carry out a predetermined work on the workpiece by performing the operation,
wherein the operation program includes:
a first operation program including the instruction for causing the sensor to perform the operation of detecting the detection data by imaging the workpiece; and
a second operation program including the instruction for causing the robot to perform the operation for the predetermined work, based on the detection data detected by executing the first operation program,
wherein the association generating unit is configured to associate the instruction included in the second operation program and the detection data used for control of the operation for the predetermined work performed by the instruction included in the second operation program with each other.

4. The device of claim 1, wherein the operation program includes:
a first instruction for calculating a correction amount for correcting the operation of the industrial machine, using the detection data; and
a second instruction for correcting the operation of the industrial machine in accordance with the correction amount calculated by executing the first instruction,
wherein the association generating unit is configured to associate the first instruction or the second instruction and the detection data with each other via the correction amount.

5. The device of claim 4, wherein the first instruction or the second instruction includes a register code representing a data storage location of the calculated correction amount,
wherein the association generating unit is configured to:
acquire information for specifying the detection data used for calculation of the correction amount; and
associate the first instruction or the second instruction and the detection data with each other via the register code, the correction amount, and the information.

6. The device of claim 1, further comprising:
an input receiving unit configured to receive an input for selecting one of the plurality of instructions; and
a data output unit configured to output the detection data associated with the one of the plurality of instructions by the association generating unit, in response to the input for selecting the one of the plurality of instructions, received by the input receiving unit.

7. The device of claim 6, further comprising an image generating unit configured to generate setting image data for setting an operation parameter of the industrial machine,
wherein the data output unit is configured to output image data of the detection data to the image generating unit,
wherein the image generating unit is configured to generate the setting image data in which the image data of the detection data is displayed.

8. The device of claim 7, wherein the input receiving unit further receives an input for changing the operation parameter through the setting image data,
wherein the device further includes a parameter setting unit configured to change the preset operation parameter in response to the input for changing the operation parameter.

9. An industrial machine comprising the device of claim 1.

10. A method of verifying an operation of an industrial machine that controls the operation based on detection data of a sensor, the method comprising:
acquiring, by a processor, the detection data detected by the sensor when executing an operation program including a plurality of instructions for causing the industrial machine to perform a plurality of the operations respectively; and
associating, by the processor, the executed instruction and the detection data used for control of the operation performed by the executed instruction with each other.
